(19) United States
(12) Patent Application Publication
(10) Pub. No.: US 2026/0109165 A1
(43) Pub. Date: Apr. 23, 2026

(54) LIQUID EJECTION HEAD AND LIQUID EJECTION APPARATUS

(71) Applicant: CANON KABUSHIKI KAISHA, Tokyo (JP)

(72) Inventors: Takuya IWANO, Tokyo (JP); Shogo KAWAMURA, Kanagawa (JP); Koji TACHIBANA, Kanagawa (JP); Tatsurou MORI, Tokyo (JP)

(21) Appl. No.: 19/363,195

(22) Filed: Oct. 20, 2025

(30) Foreign Application Priority Data
Oct. 21, 2024 (JP) 2024-185030

(51) Int. Cl. B41J 29/377; B41J 2/14; B41J 2/17; B41J 2/175; B41J 29/13

(52) U.S. Cl. CPC B41J 29/377; B41J 2/14201; B41J 2/1721; B41J 2/17523; B41J 29/13; B41J 2202/08

(57) ABSTRACT

A liquid ejection head is provided with a coolant supply portion, a coolant collection portion, and first and second liquid connection portions at the upper surface of a liquid ejection unit in a posture during use, and is provided with an absorber surrounding these portions at the upper surface of a casing. The absorber has a first opening to pass the first liquid connection portion through, a second opening to pass the coolant supply portion through, a third opening to pass the coolant collection portion through, and a fourth opening to pass the second liquid connection portion through, and in a case where the absorber is divided into three regions equal in area in a plan view seen from its upper surface, the three regions are a first region including the first opening, a second region including the second and third openings, and a third region including the fourth opening.

### BACKGROUND

### Field of the Technology

The present disclosure relates to a liquid ejection head and a liquid ejection apparatus.

### Description of the Related Art

Durability to endure long-term use is required of a liquid ejection apparatus for non-domestic settings, such as business, commercial, or industrial applications. A factor that may lower the durability of a liquid ejection head in the liquid ejection apparatus is, for example, intrusion of liquid into the head casing. Intrusion of liquid into the head casing is caused by, for example, dripping of liquid from a liquid connection portion upon attachment or detachment of the liquid ejection head to or from the liquid ejection apparatus or mist generated upon ejection of liquid such as ink. Intrusion of liquid into the head casing is problematic because adhesion of the liquid to, for example, an electric board or the like inside may cause a short in the electric circuit and break the liquid ejection head.

Japanese Patent Laid-Open No. 2015-193160 (hereinafter referred to as Literature 1) describes a configuration where a seal member sealing a gap at a liquid connection portion is provided, and further, a groove portion is provided near the seal member. This configuration allows ink to be guided to a lower part of the head along the groove portion.

However, with the configuration described in Literature 1, the ink guided to the lower part of the head may adhere to a printing medium or the liquid ejection apparatus, which may lead to degradation of the printed product or breakage of the liquid ejection apparatus.

### SUMMARY

The present disclosure is directed to reduce adhesion of liquid to a printing medium and a liquid ejection apparatus and intrusion of liquid into a casing of a liquid ejection head.

A liquid ejection head according to an aspect of the present disclosure is a liquid ejection head including: a liquid ejection unit having an ejection element substrate having an ejection element for ejecting liquid from an ejection port, a drive element substrate provided with a drive element for driving the ejection element, and a cooling member having a coolant flow channel in which a coolant for cooling the drive element substrate flows and disposed in contact with the drive element substrate; and a casing covering the liquid ejection unit. A coolant supply portion for suppling the coolant to the coolant flow channel, a coolant collection portion for collecting the coolant from the coolant flow channel, and a first liquid connection portion and a second liquid connection portion for at least supplying a liquid to the ejection element are provided at an upper surface of the liquid ejection unit with the liquid ejection head being in a posture during use. An absorber is provided at an upper surface of the casing with the liquid ejection head being in the posture during use, the absorber surrounding the coolant supply portion, the coolant collection portion, the first liquid connection portion, and the second liquid connection portion. The absorber has a first opening to pass the first liquid connection portion through, a second opening to pass the coolant supply portion through, a third opening to pass the coolant collection portion through, and a fourth opening to pass the second liquid connection portion through, and in a case where the absorber is divided into three regions which are equal in area in a plan view seen from an upper surface of the absorber, the three regions are a first region including the first opening, a second region including the second opening and the third opening, and a third region including the fourth opening.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram showing an example of a liquid ejection apparatus.

FIG. 2 is a perspective view of a liquid ejection head.

FIG. 3 is a perspective view of the liquid ejection head.

FIG. 4 is an exploded perspective view of the liquid ejection head.

FIG. 5 is a perspective view of a liquid ejection unit.

FIG. 6 is a plan view of the liquid ejection head where the liquid ejection unit is assembled to a support member, as seen from the ejection surface side.

FIG. 7 is a sectional view taken along line VII-VII in FIG. 6.

FIG. 8 is a sectional view taken along line VIII-VIII in FIG. 6.

FIGS. 9A and 9B are diagrams showing a connection configuration of liquid members between a support unit and a liquid supply unit of the liquid ejection head.

FIG. 10 is a sectional view of fluid connection portions between the liquid supply unit and a liquid supply member.

FIG. 11 is a diagram showing a connection configuration of liquid flow channels in the support unit.

FIG. 12 is a diagram showing a connection configuration of liquid flow channels in the liquid ejection unit.

FIG. 13 is a diagram showing a fluid connection configuration inside an ejection element substrate.

FIG. 14 is a perspective view of a cooling unit for cooling drive element substrates.

FIG. 15 is an exploded view of the cooling unit.

FIG. 16 is a sectional view taken along line XVI-XVI in FIG. 14.

FIG. 17 is a perspective view where an absorber is removed from the liquid ejection head.

FIG. 18 is a plan view of the liquid ejection head as seen from the direction of arrow B in FIG. 2.

FIG. 19 is a sectional view taken along line XIX-XIX in FIG. 18.

FIG. 20 is a sectional view taken along line XIX-XIX in FIG. 18.

FIG. 21 is a plan view of the absorber as seen from its upper surface.

FIGS. 22A and 22B are diagrams showing a liquid chamber in which ink flows and a liquid chamber in which a coolant flows.

FIGS. 23A to 23C are diagrams showing the relation between coolant connection portions and the drive element substrates for driving print elements on the ejection element substrates.

FIG. 24 is a diagram showing an example of the liquid ejection unit of the liquid ejection head.

FIG. 25 is an enlarged view of the liquid ejection unit shown in FIG. 24.

### DESCRIPTION OF THE EMBODIMENTS

Example embodiments of the present disclosure are described below with reference to the drawings. Note, however, that the following descriptions do not limit the scope of the present disclosure. Although the present embodiments use, as an example, an ejection method where liquid is ejected by driving of piezoelectric elements, the present disclosure can be applied to a liquid ejection head using any of various other liquid ejection methods, such as a thermal method where liquid is ejected using air bubbles generated by heater elements. Thus, a liquid ejection head may be a head having any energy generation elements configured to generate energy for ejecting liquid.

The liquid ejection apparatus of the embodiments described below is an inkjet printing apparatus (a printing apparatus) designed to circulate liquid such as ink between a tank and a liquid ejection head, but the inkjet printing apparatus may be designed differently. For example, instead of the ink circulation design, tanks may be provided upstream and downstream of a liquid ejection head to flow ink from one of the tanks to the other, thereby causing ink in pressure chambers to flow. Also, the apparatus according to the present disclosure is not limited to a printing apparatus configured to eject ink, but may be a liquid ejection apparatus configured to eject any type of liquid.

### First Embodiment

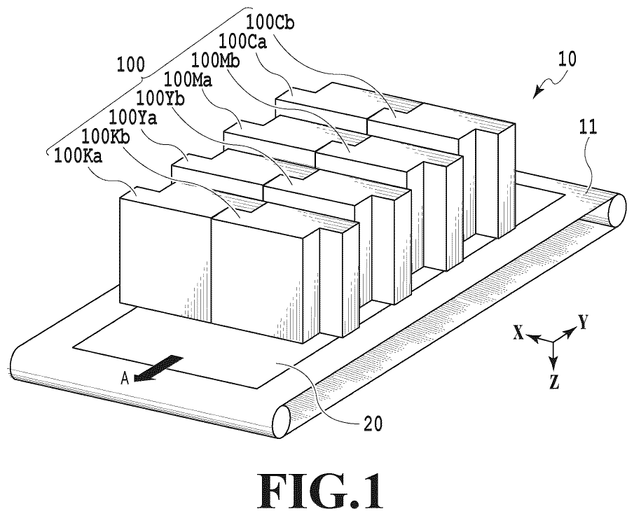

FIG. 1 is a schematic diagram showing an example of a liquid ejection apparatus 10 of the present embodiment. The liquid ejection apparatus 10 has a liquid ejection head 100 of what is called a one-pass type, where in printing of an image on a predetermined region on a printing medium 20, the printing of the image on the predetermined region is completed by one motion of the printing medium 20. The liquid ejection head 100 has ejection ports arrayed over a region corresponding to the entire width of the printing medium 20 (the X-direction in FIG. 1). The printing medium 20 is conveyed by a conveyance unit 11 in the direction indicated by arrow A and is printed by the liquid ejection head 100. The liquid ejection head 100 of the present embodiment supports a total of four colors: cyan, magenta, yellow, and black. More specifically, there are two heads for each of the colors. Specifically, the liquid ejection head 100 has cyan heads 100Ca and 100Cb, magenta heads 100Ma and 100Mb, yellow heads 100Ya and 100Yb, and black heads 100Ka and 100Kb. The following description focuses on one of these eight heads. Also, for simplification of illustration, any one of the heads is described as the liquid ejection head 100. Note that the liquid ejection head of the present disclosure may be a head of any design, and is not limited to the example shown in FIG. 1.

Also, in the description of the present embodiment, the direction in which liquid is ejected (the direction of gravitational force) is a +Z-direction, the upstream side of the direction in which the printing medium 20 is conveyed is a +Y-direction, and an array direction in which ejection ports are arrayed on the head is a +X-direction.

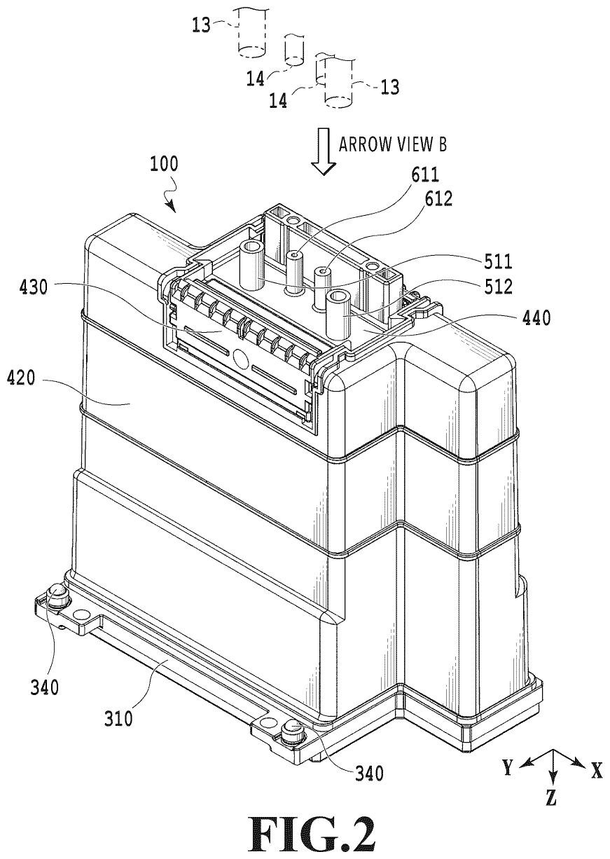

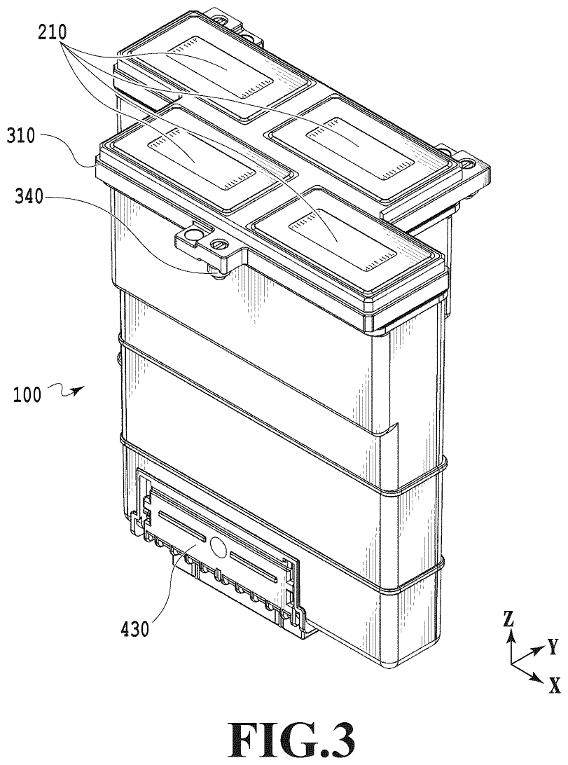

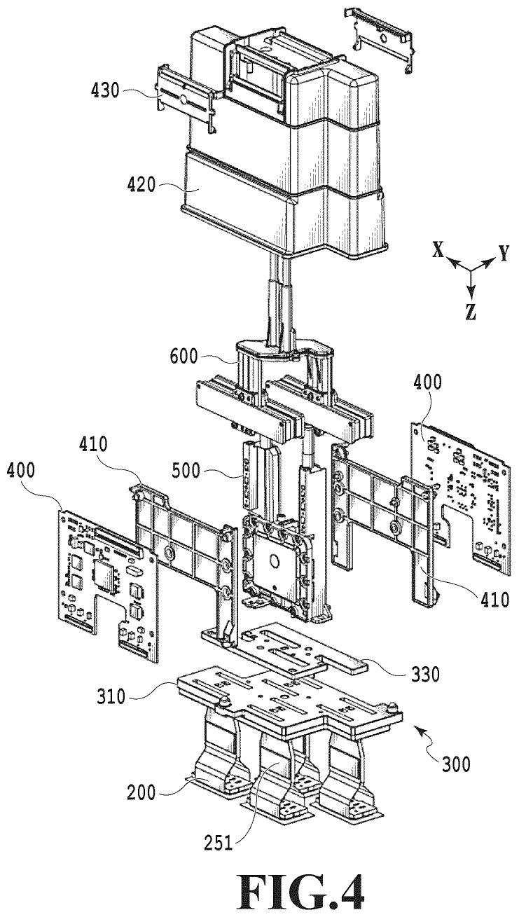

FIG. 2 is a perspective view of the liquid ejection head 100 of the present embodiment. FIG. 3 is a perspective view of the liquid ejection head 100 of the present embodiment as seen from a direction different from FIG. 2. FIG. 4 is an exploded perspective view of the liquid ejection head 100 of the present embodiment. The configuration of the liquid ejection head 100 is described using FIGS. 2 to 4. As described earlier, one of the eight heads shown in FIG. 1 is described as the liquid ejection head 100 below.

The liquid ejection head 100 is, as shown in FIG. 3, a head having four ejection element substrates 210 which are capable of ejecting liquid and are arrayed in a staggered manner on a common support member 310. Reference members 340 determine the position of the liquid ejection head 100 relative to the main body of the liquid ejection apparatus. As shown in FIG. 2, at an upper part of the liquid ejection head 100, an ink supply portion 511 and an ink collection portion 512 are provided as liquid connection portions, and a coolant supply portion 611 and a coolant collection portion 612 are provided as coolant connection portions. The liquid connection portions are connected to main-body-side liquid connection portions 13 at the main body of the liquid ejection apparatus, and the coolant connection portions are connected to main-body-side coolant connection portions 14 at the main body of the liquid ejection apparatus. They allow a coolant and a liquid such as ink to be supplied from the main body of the liquid ejection apparatus to the inside of the liquid ejection head 100. An absorber 440 is provided around the liquid connection portions and the coolant connection portions of the liquid ejection head 100. Details of the absorber 440 will be described later.

An exterior part of the liquid ejection head 100 is provided with a casing 420 and an electric-connection cover member 430 for covering and protecting an electric board, electric connections, and the like. As shown in FIG. 4, the liquid ejection head 100 internally has a support unit 300 including the common support member 310, electric wiring substrates 400, and electric-wiring-substrate support members 410 holding the respective electric wiring substrates 400. The liquid ejection head 100 also has a liquid supply unit 500 configured to supply liquid to liquid ejection units 200 through the support unit 300 and a cooling unit 600 for cooling drive circuits. The liquid ejection head 100 includes a plurality of liquid ejection units 200 or specifically four liquid ejection units 200. The following describes details of the configuration of each part of the liquid ejection head 100.

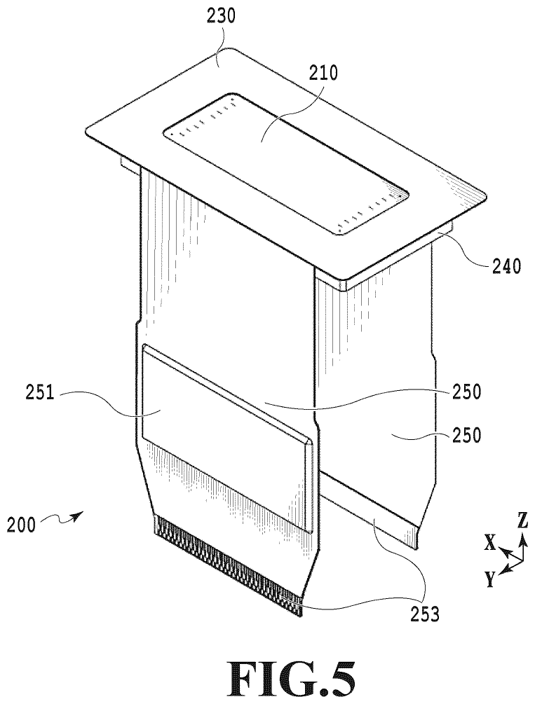

FIG. 5 is a perspective view of the liquid ejection unit 200. The liquid ejection unit 200 has the ejection element substrate 210 configured to eject liquid and a flow channel member 240 configured to supply liquid to the ejection element substrate 210. The liquid ejection unit 200 also has a drive circuit substrate 250 electrically connected to the ejection element substrate 210 and a support member 230 joined to the ejection surface side of the ejection element substrate 210. The support member 230 is joined to the ejection surface side of the ejection element substrate 210 to reduce intrusion of liquid to the electric connections between the ejection element substrate 210 and the drive circuit substrate 250 and to reinforce ejection element substrate 210. The drive circuit substrate 250 is provided with a drive element substrate 251 including drive elements for driving print elements on the ejection element substrate 210.

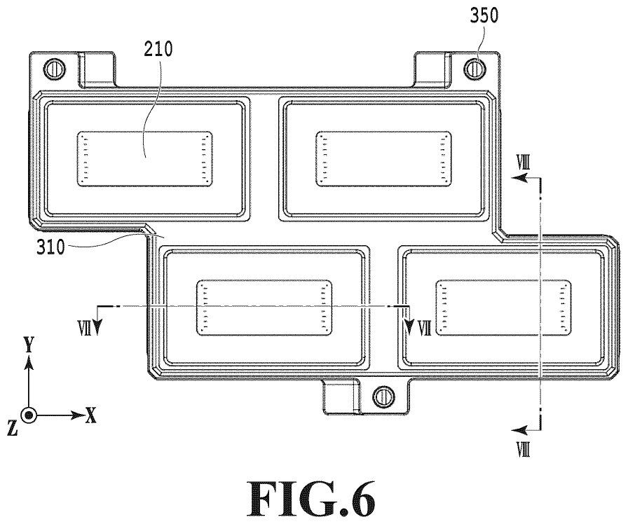

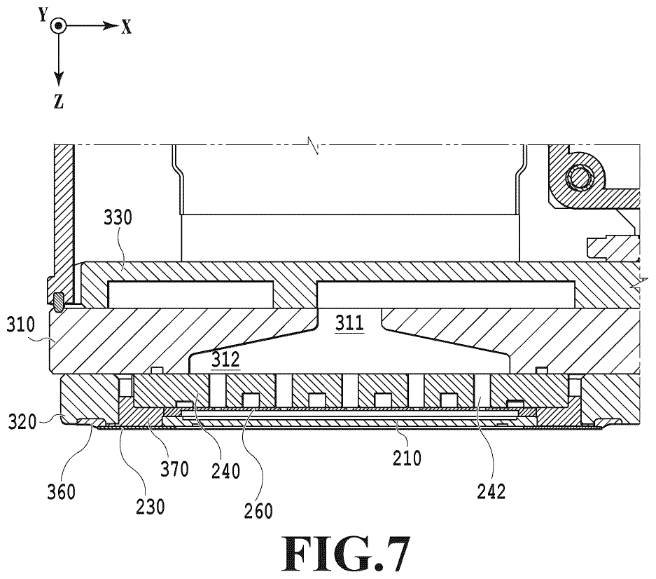

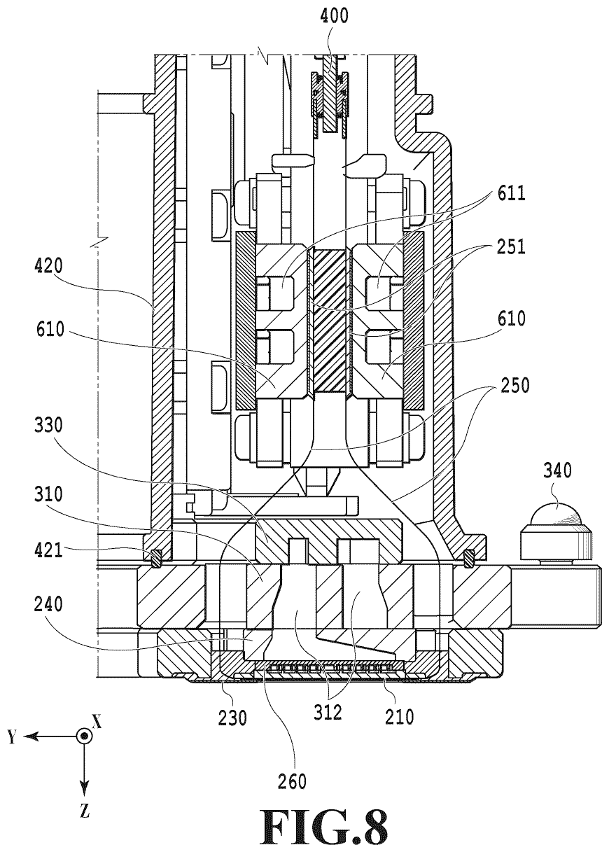

FIG. 6 is a plan view of the liquid ejection head having the liquid ejection units 200 assembled to the support unit 300, as seen from the ejection surface side. FIG. 7 is a sectional view taken along line VII-VII in FIG. 6. FIG. 8 is a sectional view taken along line VIII-VIII in FIG. 6. Note that FIG. 8 is a sectional view taken along VIII-VIII in FIG. 6 not only with the liquid ejection unit 200 being assembled to the support unit 300, but also with other members being assembled thereto. As shown in FIGS. 7 and 8, the flow channel member 240 and a liquid supply member 330 are joined to the common support member 310, fluidically connecting liquid flow channels. A space between the periphery of the support member 230 and a frame member 320 is sealed by a periphery seal member 360 to reduce liquid intrusion. The back surface of the support member 230 (the surface opposite from the ejection surface) may be sealed by a back-surface seal member 370 for reinforcement. As shown in FIG. 6, three holes are opened in the common support member 310 to insert reference fixation members 350 therethrough. The reference fixation members 350 are fixed in these holes, and the reference members 340 are fixed to these reference fixation members 350. The reference fixation members 350 may be integral with the common support member 310.

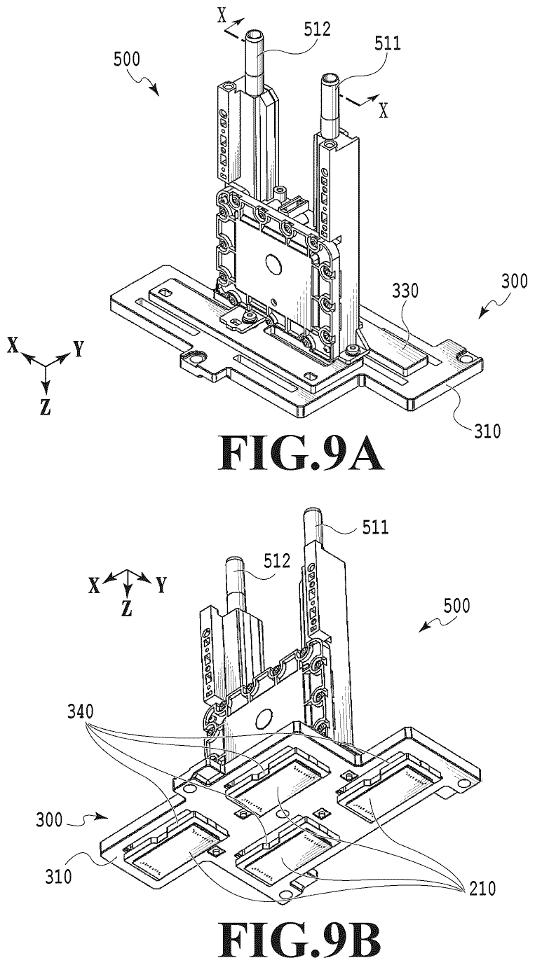

FIGS. 9A and 9B are diagrams showing a connection configuration of liquid members between the support unit 300 and the liquid supply unit 500 of the liquid ejection head 100 according to the present embodiment. FIG. 9A is a perspective view seen from the upper surface, and FIG. 9B is a perspective view seen from the bottom surface. The liquid supply unit 500 has the ink supply portion 511 and the ink collection portion 512 as the liquid connection portions, and they are connected to the main-body side liquid connection portions 13 (FIG. 2) at the main body of the liquid ejection apparatus. This allows liquid to be supplied from the supply system of the main body of the liquid ejection apparatus to the liquid ejection head 100 and allows liquid having passed the liquid ejection head 100 to be collected to the supply system of the main body of the liquid ejection apparatus. In this way, liquid can be circulated through a path in the main body of the liquid ejection apparatus and a path in the liquid ejection head 100. To remove foreign matter in ink supplied, a filter (not shown) communicating with each of the openings of the liquid connection portions is provided inside the liquid supply unit 500.

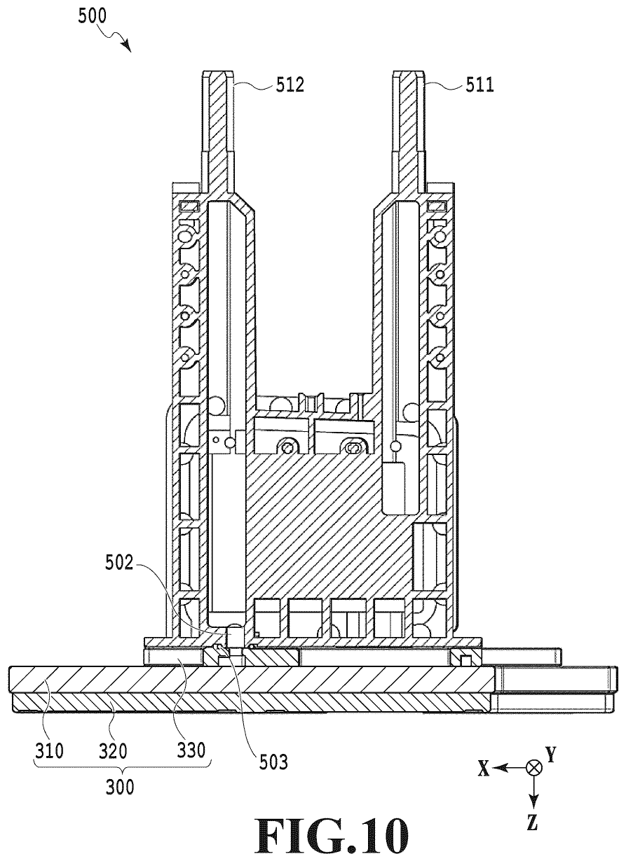

FIG. 10 is a sectional view of fluid connection portions between the liquid supply unit 500 and the liquid supply member 330. FIG. 10 is a sectional view taken along line X-X in FIG. 9A. Liquid flowing in from the main body of the liquid ejection apparatus through the liquid connection portion passes through a communication port 502 and is supplied to the liquid supply member 330. A space between the liquid supply unit 500 and the liquid supply member 330 is sealed by an elastic member 503.

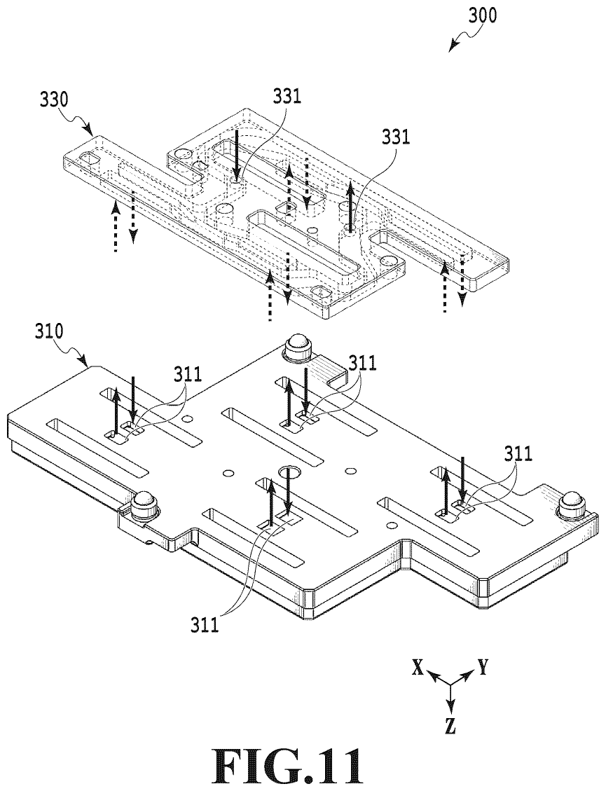

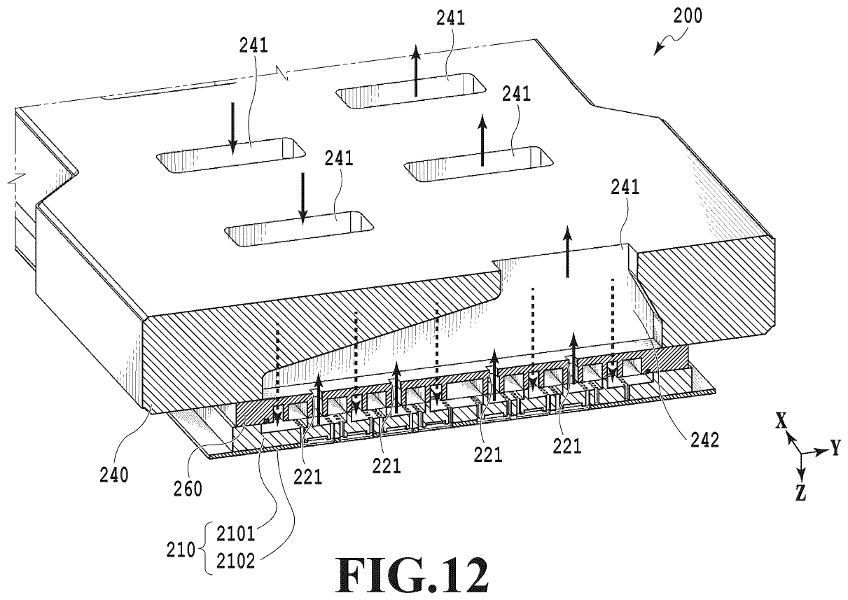

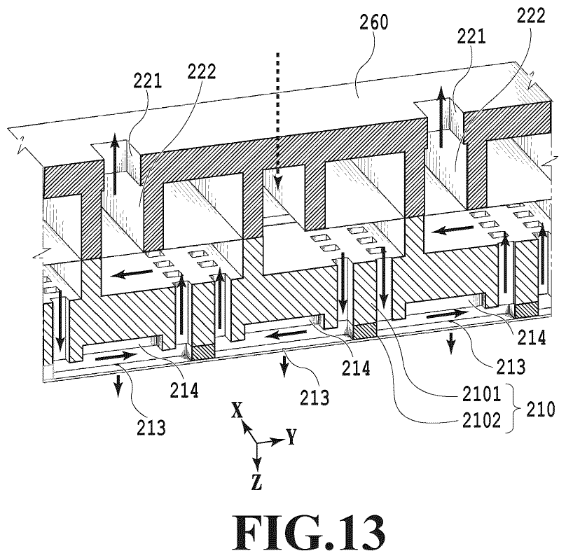

FIG. 11 is a diagram showing a connection configuration of liquid flow channels in the support unit 300. FIG. 12 is a diagram showing a connection configuration of liquid flow channels in the liquid ejection unit 200. The liquid supply unit 500 and the liquid supply member 330 in the support unit 300 are fluidically connected through first communication ports 331. Flow channels are formed in the liquid supply member 330 to distribute liquid to each of the liquid ejection units 200. In the present embodiment, flow channels for distributing liquid to the four liquid ejection units 200 are formed inside the single liquid supply member 330. The liquid supply member 330 and the common support member 310 are fluidically connected by second communication ports 311. As shown in FIG. 12, the common support member 310 and each of the liquid ejection units 200 are fluidically connected by third communication ports 241 in the flow channel member 240. A liquid flow channel 242 is formed in the flow channel member 240. The flow channel member 240 is fluidically connected to a flow channel conversion member 260 through fourth communication ports 221. FIG. 13 is a diagram showing a fluid connection configuration in the ejection element substrate 210. Liquid flowing in from each of the fourth communication ports 221 is supplied to the ejection element substrate 210 through a common flow channel 222, and is ejected through an ejection port 213 by a piezoelectric element 214 which is an ejection element. The ejection element substrate 210 includes a first substrate 2101 joined to the flow channel conversion member 260 and a second substrate 2102 where the ejection ports 213 are formed.

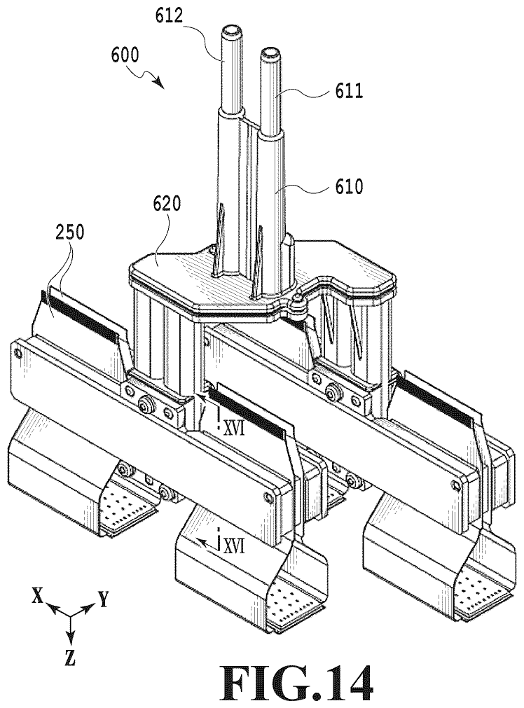

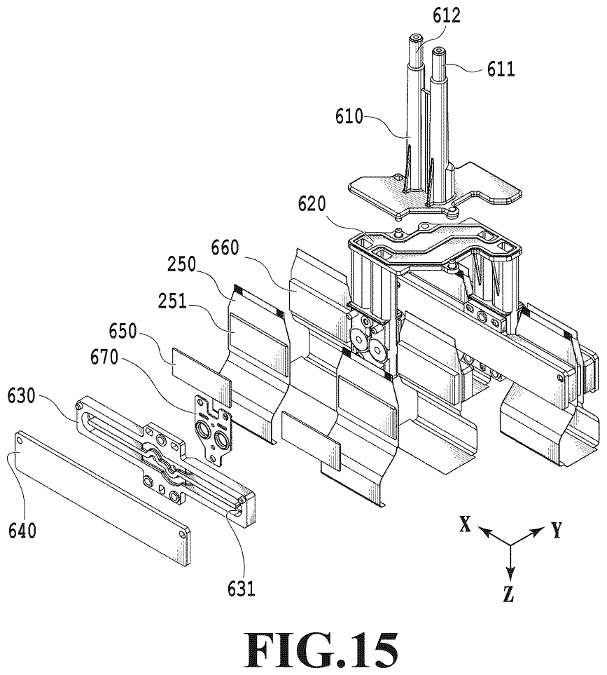

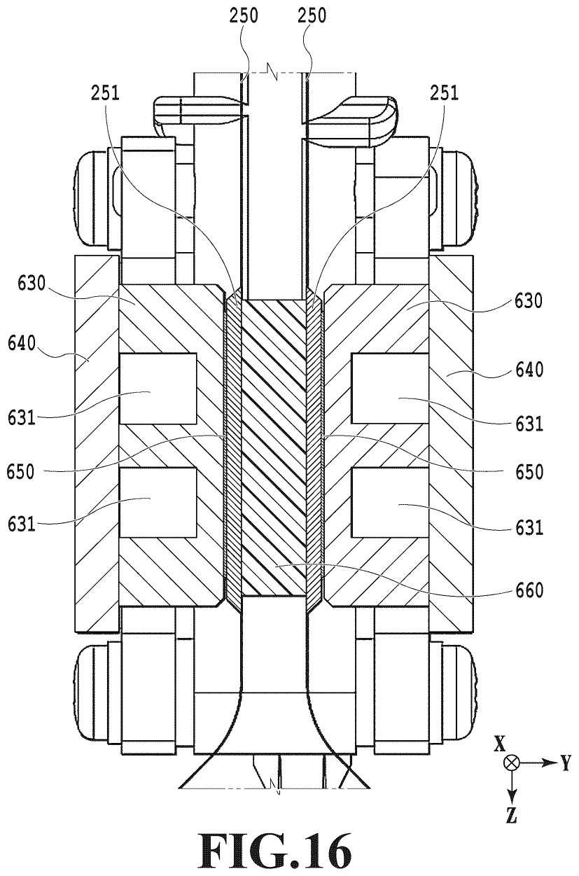

FIG. 14 is a perspective view of the cooling unit 600 for cooling the drive element substrates 251. FIG. 15 is an exploded view of the cooling unit 600. FIG. 16 is a sectional view taken along line XVI-XVI in FIG. 14. The drive element substrate 251 is disposed at each of the drive circuit substrates 250. FIG. 14 shows a state where the drive element substrates 251 are covered by the cooling unit 600. As shown in FIG. 14, the cooling unit 600 has the coolant supply portion 611 and the coolant collection portion 612 as coolant connection portions. The coolant supply portion 611 and the coolant collection portion 612 are connected to the coolant connection portions 14 (see FIG. 2) on the main body of the liquid ejection apparatus. Thus, a coolant is supplied from the coolant supply system of the main body of the liquid ejection apparatus to the cooling unit 600, and the coolant having passed through the cooling unit 600 is collected to the coolant supply system of the main body of the liquid ejection apparatus. In this way, a coolant can be circulated through a path in the main body of the liquid ejection apparatus and a path in the cooling unit 600. As shown in FIG. 15, the coolant flowing in through the coolant supply portion 611 diverges through a coolant flow channel formed between a first coolant supply member 610 and a second coolant supply member 620. The second coolant supply member 620 and a first cooling member 630 are fluidically connected with a seal member 670 interposed in between. The coolant diverging in the second coolant supply member 620 is circulated inside a coolant flow channel 631 formed between the first cooling member 630 and a second cooling member 640 and flows into the second coolant supply member 620 again. Then, the coolant flowing into the second coolant supply member 620 again merges in a coolant flow channel formed between the first coolant supply member 610 and the second coolant supply member 620 and flows out through the coolant collection portion 612.

The cooling unit 600 of the present embodiment has four sets of the first cooling member 630 and the second cooling member 640. The second coolant supply member 620 is divided into two cooling systems in the Y-direction. Each cooling system has two sets of the first cooling member 630 and the second cooling member 640. These two sets are provided facing each other in the Y-direction. Also, heat conduction members 650 are provided between these two sets in the Y-direction and abut against the first cooling member 630.

The first cooling member 630 thus abuts against the drive element substrate 251 with the heat conduction member 650 interposed in between, achieving a configuration where heat generated while the drive element substrate 251 is operated is transferred to the coolant in the first cooling member 630. In order to make it easier for the first cooling member 630 to transfer the heat generated in the drive element substrate 251, a member with the highest possible thermal conductivity, such as aluminum, may be selected for the first cooling member 630. An elastic member 660 is provided between two drive circuit substrates 250, ensuring that the heat conduction member 650 may be brought into close contact with the drive element substrate 251.

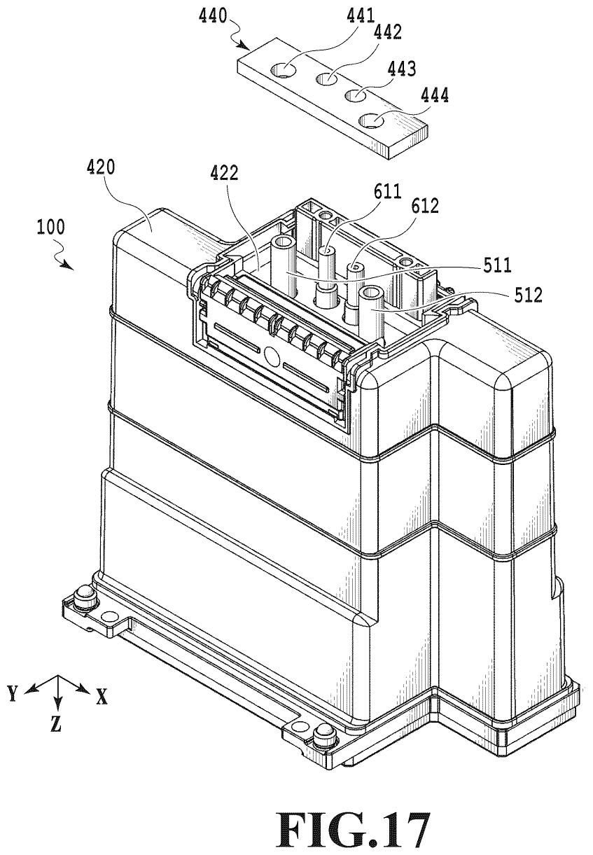

FIG. 17 is a perspective view where the absorber 440 is removed from the liquid ejection head 100 in FIG. 2. As described earlier, the liquid ejection head 100 is, at its upper part in the vertical direction (the −Z-direction), provided with the ink supply portion 511 and the ink collection portion 512 as liquid connection portions and the coolant supply portion 611 and the coolant collection portion 612 as coolant connection portions. The fluidic connection of the liquid connection portions and the coolant connection portions to the main-body-side liquid connection portions 13 and the main body-side coolant connection portions 14, respectively, enables supply of the ink and the coolant to the liquid ejection head 100 and collection of the supplied ink and coolant to the main body side. The liquid connection portions and the coolant connection portions are also collectively referred to as fluid connection portions.

Upon, e.g., insertion or removal of the fluid connection portions to or from the main body of the liquid ejection apparatus 10, the ink or coolant may leak from the liquid ejection apparatus side. The leaked ink or coolant may adhere to the liquid ejection head 100. Also, mist generated by ink ejection may fly and adhere to the liquid ejection head 100. The liquid ejection head 100 is covered by the casing 420 so as not to break due to adhesion of ink mist, ink or coolant leaking from the portions of connection to the liquid ejection head 100, or the like to the drive circuit substrates 250 or the electric wiring substrates 400.

A recessed portion 422 is provided at an upper part of the casing 420, surrounding the ink supply portion 511, the ink collection portion 512, the coolant supply portion 611, and the coolant collection portion 612. Also, penetration holes are formed in the upper part of the casing 420 to allow the ink supply portion 511, the ink collection portion 512, the coolant supply portion 611, and the coolant collection portion 612 to pass through. Penetration holes are formed in the absorber 440 to allow the ink supply portion 511, the ink collection portion 512, the coolant supply portion 611, and the coolant collection portion 612 to pass through.

In the present embodiment, as shown in FIGS. 2 and 17, the absorber 440 is attached to the recessed portion 422 provided at the casing 420. Specifically, the absorber 440 is attached to the recessed portion 422 with the ink supply portion 511, the ink collection portion 512, the coolant supply portion 611, and the coolant collection portion 612 passing through the penetration holes formed in the absorber 440. As a result, the lower surface of the absorber 440 and the upper surface of the recessed portion 422 are in contact with each other. The absorber 440 thus attached can help prevent ink mist or the like from intruding into the casing 420 through gaps between the casing 420 and the ink supply portion 511, the ink collection portion 512, the coolant supply portion 611, and the coolant collection portion 612. In other words, the absorber 440 absorbs ink mist, an ink or coolant leaking from portions of connection between the liquid ejection head 100 and the liquid ejection apparatus 10, or the like. This helps prevent the ink mist and the like from intruding into the casing 420.

Further, the absorber 440 is housed in the recessed portion 422 provided at the top surface of the casing 420 to retain liquid and the like in the absorber 440, making it possible to reduce the amount of liquid leaking to the lower part of the liquid ejection head 100. Thus, breakage of the liquid ejection apparatus and smearing on a printed medium can be reduced.

Note that as shown in FIG. 17, the outer diameter portions of the ink supply portion 511 and the ink collection portion 512 as liquid connection portions have a straight shape in the present embodiment. As an example, the outer diameter of each liquid connection portion is φ6 mm. Meanwhile, the outer diameter portions of the coolant supply portion 611 and the coolant collection portion 612 as coolant connection portions have a two-level shape. Specifically, the coolant supply portion 611 and the coolant collection portion 612 each have an outer diameter shape such that the outer diameter of a side closer to the casing 420 is larger than that of a side connected to the main body of the liquid ejection apparatus 10. For example, the outer diameter of the coolant connection portion is φ5.2 mm on the casing side and is φ4 mm on the main body side. Also, the coolant connection portions are configured so that their inner diameters are smaller than the inner diameters of the liquid connection portions.

In the present embodiment, the main-body-side liquid connection portions 13 and the main-body-side coolant connection portions 14 are formed of tubes. Thus, the tubes are to be connected to the tips of the liquid connection portions and the coolant connection portions. Connection of the tubes to attach the liquid ejection head 100 to the liquid ejection apparatus 10 is done manually. Thus, to prevent incorrect insertion of the tubes to the liquid connection portions and the coolant connection portions, the liquid connection portions and the coolant connection portions have different outer diameters. Specifically, as described earlier, the coolant connection portions are smaller (i.e., thinner) in outer diameter than the liquid connection portions. Note that if the coolant connection portions entirely had the thinner outer diameter of the side connected to the main body of the liquid ejection apparatus 10 and had a straight shape like the liquid connection portions, the inner diameter portion would be thin and long, which would lower the molding strength of injection molding or increase pressure loss. Thus, the coolant supply portion 611 and the coolant collection portion 612 as coolant connection portions of the present embodiment each have an outer diameter shape such that a side closer to the casing 420 is larger in outer diameter than a side connected to the main body of the liquid ejection apparatus 10. Meanwhile, the outer diameter portions of the ink supply portion 511 and the ink collection portion 512 as liquid connection portions have a straight shape because they have sufficiently thick diameters and therefore do not need to have the two-level configuration.

Note that it is conceivable to make the coolant supply portion 611 and the coolant collection portion 612 have an outer diameter shape such that the side closer to the casing 420 is smaller in outer diameter than the side connected the main body of the liquid ejection apparatus 10. However, in this case, after the attachment of the absorber 440, relatively large gaps are left between the absorber 440 and the coolant connection portions. Thus, as shown in FIG. 17, to help prevent intrusion of liquid into the casing 420, the coolant connection portions of the present embodiment have an outer diameter shape such that the side closer to the casing 420 is larger in outer diameter than the side connected to the main body of the liquid ejection apparatus 10.

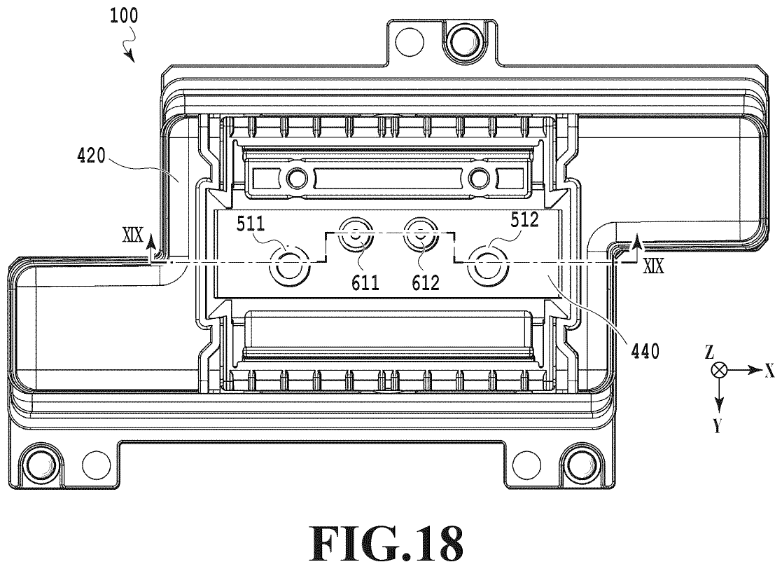

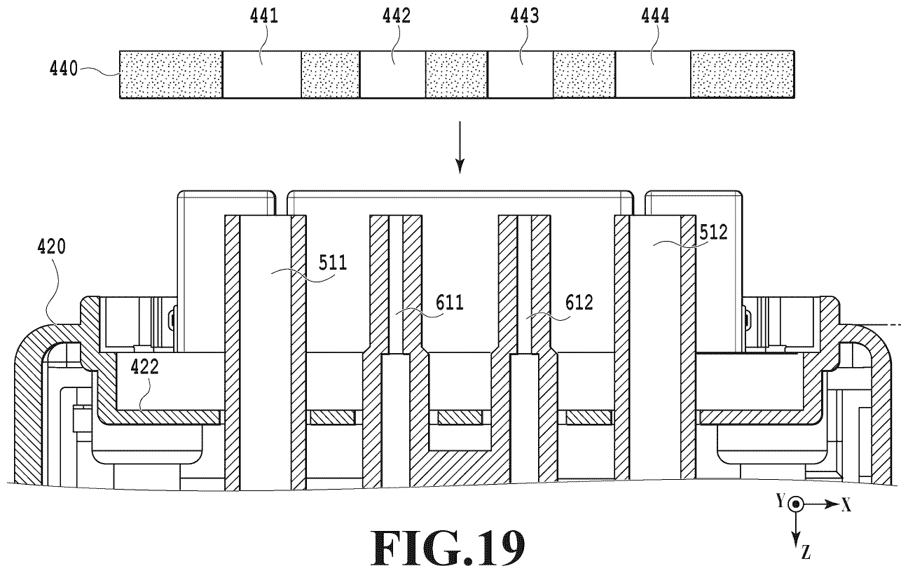

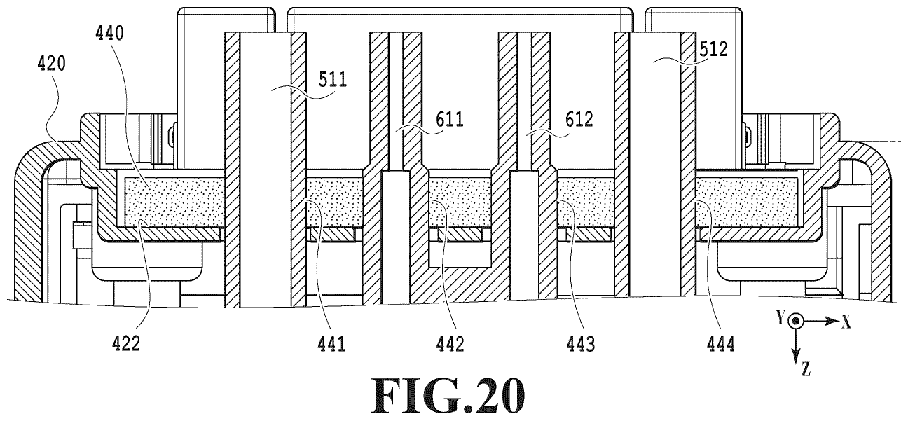

FIG. 18 is a plan view of the liquid ejection head 100 as seen from the direction of arrow B in FIG. 2. FIGS. 19 and 20 are sectional views taken along line XIXXIX in FIG. 18. FIG. 19 is a sectional view of a state before the absorber 440 is attached, and FIG. 20 is a sectional view of a state after the absorber 440 is attached.

In the absorber 440, a first opening 441, a second opening 442, a third opening 443, and a fourth opening 444 are formed sequentially from the left side of the drawings. The first opening 441 and the fourth opening 444 correspond to the liquid connection portions, and the second opening 442 and the third opening 443 correspond to the coolant connection portions. More specifically, the first opening 441, the second opening 442, the third opening 443, and the fourth opening 444 correspond to the ink supply portion 511, the coolant supply portion 611, the coolant collection portion 612, and the ink collection portion 512, respectively. The absorber 440 is attached to the liquid ejection head 100 with the liquid connection portions and the coolant connection portions passing through the corresponding ones of the first opening 441, the second opening 442, the third opening 443, and the fourth opening 444.

The hole diameters of the first opening 441, the second opening 442, the third opening 443, and the fourth opening 444 of the absorber 440 are smaller than the outer diameters of the ink supply portion 511, the coolant supply portion 611, the coolant collection portion 612, and the ink collection portion 512, respectively. This brings the absorber 440 into closer contact with the ink supply portion 511, the coolant supply portion 611, the coolant collection portion 612, and the ink collection portion 512. Thus, intrusion of liquid into the casing 420 can be effectively reduced. As an example, the first opening 441 and the fourth opening 444 are φ5.8 mm in hole diameter, and the second opening 442 and the third opening 443 are φ5.1 mm in hole diameter.

Note that the present disclosure is not limited to the example described in the present embodiment where the recessed portion 422 is formed at the upper part of the casing 420 and the absorber 440 is attached within the recessed portion 422. The provision of the recessed portion 422 achieves a configuration where the absorber 440 is surrounded from all directions and thus makes it easier to reduce adhesion of ink or the like coming from the surrounding area and directed into the casing 420. Nonetheless, the liquid ejection head 100 may be configured without the recessed portion 422.

From the perspective of reducing ink intrusion, the taller the absorber 440 in the vertical direction, the better. However, the liquid connection portions and the coolant connection portions need to be exposed at regions to which the tubes on the main body side are to be connected. For this reason, the absorber 440 is at a height such that the liquid connection portions and the coolant connection portions are exposed to such an extent as to enable tube connection.

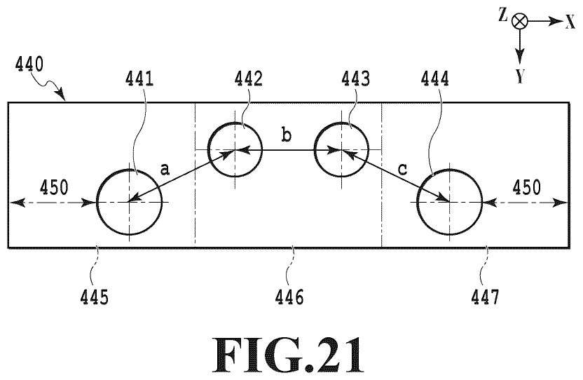

FIG. 21 is a plan view of the absorber 440 as seen from its upper surface. In a plan view, the absorber 440 has a first region 445 including the first opening 441, a second region 446 including the second opening 442 and the third opening 443, and a third region 447 including the fourth opening 444. In the present embodiment, borders are determined so that the first region 445, the second region 446, and the third region 447 may be equal in area in a plan view of the absorber 440 seen from its upper surface with the liquid ejection head 100 being in a posture during use. Note that “equal in area” does not have to mean exactly equal as long as the first region 445, the second region 446, and the third region 447 have almost equal areas. For example, the area ratio of the first region 445, the second region 446, and the third region 447 may be 3:3:4 or the like.

Note that the border between the first region 445 and the second region 446 may be determined using any method, but needs to be determined using the same method as that used for determining the border between the second region 446 and the third region 447. For example, the direction in which the openings in the absorber 440 are arranged is a first direction, and the first direction corresponds to the X-direction. The first direction is also a direction along the longer side of the absorber 440. A line which passes through a midpoint between the center of the first opening 441 and the center of the second opening 442 adjacent to the first opening 441 in the first direction and extended in a second direction (the Y-direction) orthogonal to the first direction is set as the border between the first region 445 and the second region 446. Similarly, a line which passes through a midpoint between the center of the fourth opening 444 and the center of the third opening 443 adjacent to the fourth opening 444 in the first direction and extended in the second direction (the Y-direction) is set as the border between the second region 446 and the third region 447. Although the centers of the openings are used in the example described here, the outer edge portions may be used. Either case may be used as long as the absorber 440 can be divided into the first region 445 including the first opening 441, the second region 446 including the second opening 442 and the third opening 443, and the third region 447 including the fourth opening 444. The second region 446 is disposed between the first region 445 and the third region 447 in the first direction.

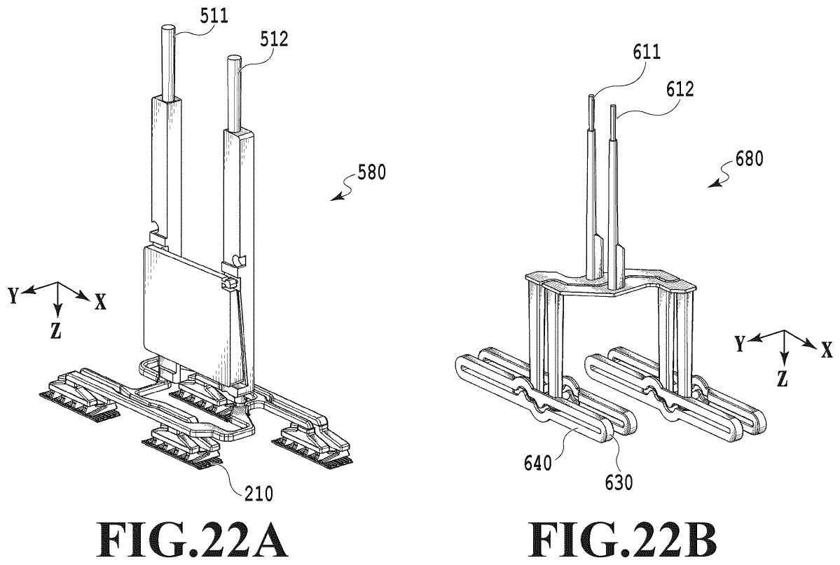

FIGS. 22A and 22B are diagrams showing a liquid chamber (a flow channel) in which ink flows and a liquid chamber (a flow channel) in which a coolant flows. FIGS. 22A and 22B juxtapose an ink supply system 580 and a coolant supply system 680 for size comparison. As shown in FIGS. 22A and 22B, in the present embodiment, the liquid chamber (flow channel) through which ink is supplied to the ejection element substrates 210 is larger in capacity than the liquid chamber (flow channel) through which a coolant is supplied to a cooling member formed by the first cooling member 630 and the second cooling member 640. Further, as shown in FIGS. 17 to 20 and 22, the ink supply portion 511 and the ink collection portion 512 are larger in outer diameter than the coolant supply portion 611 and the coolant collection portion 612. In such a case, the amount of liquid that might leak upon insertion or removal of the fluid connection portions to or from the liquid ejection apparatus 10 is more likely to be relatively larger for the ink than for the coolant.

Here in the present embodiment, the first region 445 and the third region 447 of the absorber 440 are disposed outward in the first direction at the absorber 440. Thus, expanding the outer regions of the absorber 440 makes it possible for the absorber 440 to have a larger capacity to absorb ink. For example, the first region 445 and the third region 447 have projecting regions 450 projecting more outward in the first direction than the ink supply portion 511 and the ink collection portion 512, respectively. Further, disposing the ink supply portion 511 and the ink collection portion 512 as far outward as possible in the first direction can also expand the regions for ink absorption.

As shown in FIG. 21, “b<a” or “b<c” may be satisfied, where a is the distance between the ink supply portion 511 and the coolant supply portion 611, b is the distance between the coolant supply portion 611 and the coolant collection portion 612, and c is the distance between the ink collection portion 512 and the coolant collection portion 612. More suitably, “b<a” and “b<c” may be satisfied. In other words, the liquid absorption capacity of at least one of the first region 445 and the third region 447 may be larger than that of the second region 446. This makes it possible to increase the absorbable capacity for ink, which is more likely to leak in a larger amount than the coolant.

Note that the present disclosure is not limited to the example described in the present embodiment where the first region 445, the second region 446, and the third region 447 are formed by the single integral absorber 440. For example, separate absorbers may be used for the respective regions. In this case, for example, the absorbers for the first region 445 and the third region 447 may be thicker than the absorber for the second region 446. In this way, liquid absorption effect can be enhanced by changing the densities, widths, thicknesses, and the like of the absorbers according to an estimated amount of liquid leakage in each region.

The present disclosure is not limited to the example described in the present embodiment where the first opening 441, the second opening 442, the third opening 443, and the fourth opening 444 correspond to the ink supply portion 511, the coolant supply portion 611, the coolant collection portion 612, and the ink collection portion 512, respectively. The supply portions and the collection portions may be reversed. For example, the first opening 441, the second opening 442, the third opening 443, and the fourth opening 444 may correspond to the ink collection portion, the coolant collection portion, the coolant supply portion, and the ink supply portion, respectively. Alternatively, the first opening 441, the second opening 442, the third opening 443, and the fourth opening 444 may correspond to the ink collection portion, the coolant supply portion, the coolant collection portion, and the ink supply portion, respectively.

Also, the present disclosure is not limited to the example described in the present embodiment where the ink supply portion 511 and the ink collection portion 512 are larger in outer diameter than the coolant supply portion 611 and the coolant collection portion 612. The present embodiment can be similarly applied to a configuration where the amount of liquid that might leak upon insertion or removal of the fluid connection portions to and from the liquid ejection apparatus 10 is more likely to be relatively larger for the ink than for the coolant. Specifically, the configuration may be such that at least one of the ink supply portion 511 and the ink collection portion 512 is larger in outer diameter than the coolant supply portion 611 and the coolant collection portion 612. In this case, it is still more likely that the amount of liquid that might lead upon insertion or removal of the fluid connection portions is relatively larger for the ink than for the coolant.

The present embodiment describes an example where the coolant connection portions are disposed toward the center in the first direction, and the liquid connection portions are disposed outward in the first direction. Then, in the example described above, the first region 445, the second region 446, and the third region 447 are provided because it is estimated that the liquid may leak more at the liquid connection portions than at the coolant connection portions. The following describes the reason why the coolant connection portions are disposed toward the center.

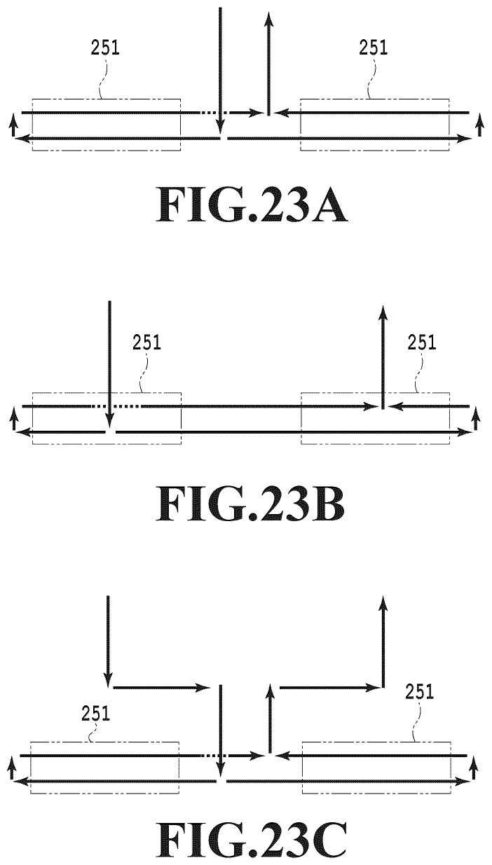

FIGS. 23A to 23C are diagrams showing the relation between the coolant connection portions and the drive element substrates 251 for driving the print elements on the ejection element substrates 210. FIGS. 23A to 23C show the drive element substrates 251 in FIGS. 14 and 15, as seen in the Y-direction. Also, the arrows indicate the flow of the coolant. FIG. 23A is a diagram showing the relation described in the present embodiment. FIGS. 23B and 23C are diagrams showing comparative examples different from the configuration of the present embodiment.

In the present embodiment, the liquid ejection head 100 is provided with a plurality of drive element substrates 251. As described earlier, the coolant flow channel is configured to diverge midway and cool the plurality of the drive element substrates 251. Although FIGS. 23A to 23C show two drive element substrates 251, there are two more drive element substrates 251 provided at opposing positions at the other side, as shown in FIGS. 14 and 15. Thus, the coolant flow channel is configured to cool the four drive element substrates 251. With a configuration where the coolant connection portions are provided inward like the configuration of the present embodiment shown in FIG. 23A, the drive element substrates 251 can be cooled evenly by the flow of the coolant. Specifically, the drive element substrates 251 are provided substantially symmetrically with the coolant connection portions at the center, and the coolant flow channel is configured to diverge toward the symmetrically provided drive element substrates 251. Thus, the coolant flowing into the liquid ejection head 100 can cool the drive element substrates 251 evenly. A case is now considered where the coolant connection portions are provided outward as shown in the comparative example in FIG. 23B. For example, the comparative example shown in FIG. 23B is a case where the coolant connection portions and the liquid connection portions are reversed in positional relation compared to the present embodiment. In a case where the coolant connection portions are provided outward, the flow channel arrangement is unbalanced. As a result, the cooling effect on the drive element substrates 251 may be uneven. In a case where the coolant connection portions are provided outward, like in the comparative example shown in FIG. 23C, it is conceivable to convert the coolant flow channels inward. Although the cooling effect can be evened out in the case of FIG. 23C, the flow channels would be complicated, increasing the size of the liquid ejection head 100. Further, the longer flow channels lowers the cooling effect.

This is why the coolant connection portions may be provided inward as shown in FIG. 23A. For those reasons, in the liquid ejection head 100 of the present embodiment, the coolant connection portions are disposed toward the center in the first direction, and the liquid connection portions are disposed outward in the first direction. Then, because it is estimated that liquid may leak more at the liquid connection portions than at the coolant connection portions, the first region 445, the second region 446, and the third region 447 are provided as described above.

As thus described, the present embodiment can reduce adhesion of liquid to a printing medium and the liquid ejection apparatus and intrusion of liquid into the casing of the liquid ejection head. To this end, in the present embodiment, the absorber 440 is disposed to surround the liquid connection portions and the coolant connection portions provided at the upper part of the casing 420 of the liquid ejection head 100. The absorber 440 is configured to have a larger absorption region for the liquid connection portions, where liquid leak is estimated to leak more, than for the coolant connection portions. This makes it possible to increase the absorbable capacity for the liquid which is likely to leak in a larger amount.

### Second Embodiment

The first embodiment describes an example where the ink supply portion 511 and the ink collection portion 512 are provided as the liquid connection portions. Specifically, the first embodiment describes an example where the ink supply portion 511 is provided as the first liquid connection portion and the ink supply portion 511 is provided as the second liquid connection portion. The present embodiment describes an example where a first ink supply portion as a first liquid connection portion and a second ink supply portion as a second liquid connection portion are provided as the liquid connection portions. Specifically, an example is described here where the liquid ejection head of the present embodiment is configured not to circulate liquid between the liquid ejection head and the main body of the liquid ejection apparatus. As an example, the ink supply portion 511 and the ink collection portion 512 described in the first embodiment are used as the first ink supply portion and the second ink supply portion, respectively. In this case, the basic configuration is still the same as the example described in the first embodiment. Note that part of the flow channel configuration differs from the first embodiment.

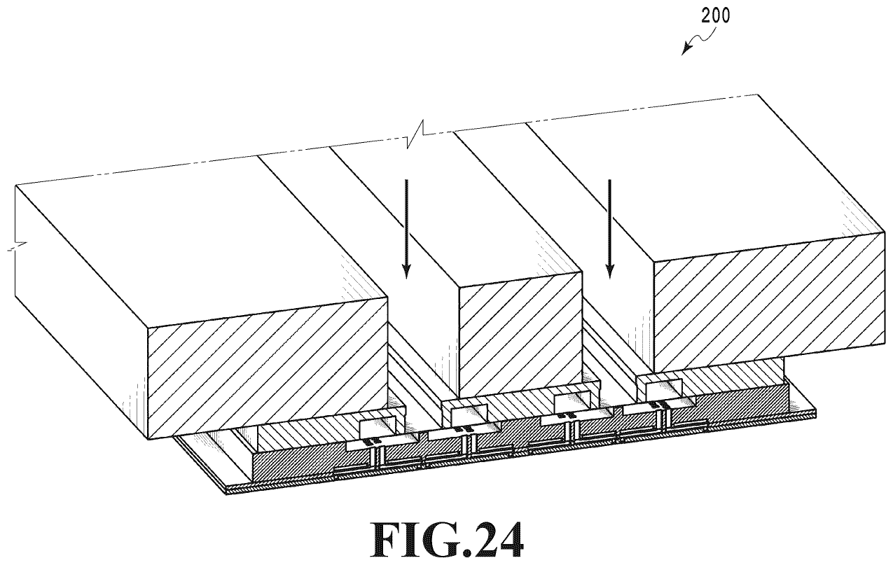

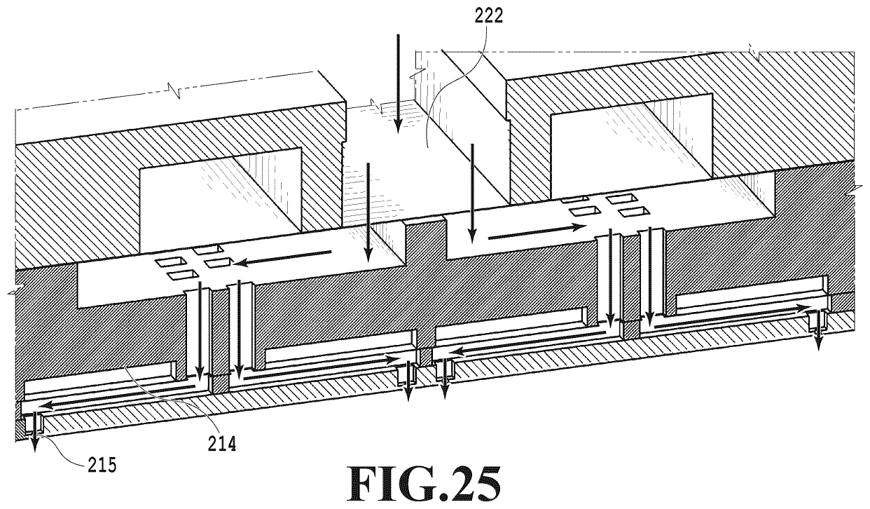

FIG. 24 is a diagram showing an example of the liquid ejection unit 200 in the liquid ejection head of the present embodiment. FIG. 25 is an enlarged view of the liquid ejection unit 200 in FIG. 24. The arrows in FIGS. 24 and 25 indicate the flow of ink. As shown in FIGS. 24 and 25, in the present embodiment, ejection is performed using ink supplied from both of the first ink supply portion and the second ink supply portion. Note that as shown in FIGS. 24 and 25, ink ejected using the piezoelectric element 214 is ink supplied from one of the first ink supply portion and the second ink supply portion.

Thus, even in a mode where the liquid ejection head is configured not to circulate liquid between the liquid ejection head and the main body of the liquid ejection apparatus, adhesion of liquid to a printing medium and the liquid ejection apparatus and intrusion of liquid into the casing of the liquid ejection head can be reduced as described in the first embodiment.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

The present disclosure can reduce adhesion of liquid to a printing medium and the liquid ejection apparatus and intrusion of liquid into the casing of the liquid ejection head.

This application claims the benefit of Japanese Patent Application No. 2024-185030, filed Oct. 21, 2024, which is hereby incorporated by reference herein in its entirety.

What is claimed is:

1. A liquid ejection head comprising:
a liquid ejection unit having an ejection element substrate having an ejection element for ejecting liquid from an ejection port, a drive element substrate provided with a drive element for driving the ejection element, and a cooling member having a coolant flow channel in which a coolant for cooling the drive element substrate flows and disposed in contact with the drive element substrate; and
a casing covering the liquid ejection unit, wherein
a coolant supply portion for suppling the coolant to the coolant flow channel, a coolant collection portion for collecting the coolant from the coolant flow channel, and a first liquid connection portion and a second liquid connection portion for at least supplying a liquid to the ejection element are provided at an upper surface of the liquid ejection unit with the liquid ejection head being in a posture during use,
an absorber is provided at an upper surface of the casing with the liquid ejection head being in the posture during use, the absorber surrounding the coolant supply portion, the coolant collection portion, the first liquid connection portion, and the second liquid connection portion,
the absorber has a first opening to pass the first liquid connection portion through, a second opening to pass the coolant supply portion through, a third opening to pass the coolant collection portion through, and a fourth opening to pass the second liquid connection portion through, and
in a case where the absorber is divided into three regions which are equal in area in a plan view seen from an upper surface of the absorber, the three regions are a first region including the first opening, a second region including the second opening and the third opening, and a third region including the fourth opening.

2. The liquid ejection head according to claim 1, wherein
an upper surface of the casing is provided with a recessed portion, and
a lower surface of the absorber is in contact with an upper surface of the recessed portion.

3. The liquid ejection head according to claim 1, wherein
the second region of the absorber is disposed between the first region and the third region in a plan view seen from an upper surface of the casing.

4. The liquid ejection head according to claim 1, wherein
at least one of the first region and the third region of the absorber has a larger liquid absorption capacity than the second region.

5. The liquid ejection head according to claim 1, wherein
a liquid chamber through which the liquid is supplied to the ejection element substrate is larger in capacity than a liquid chamber through which the coolant is supplied to the cooling member.

6. The liquid ejection head according to claim 1, wherein
a distance between a center of the first liquid connection portion and a center of the coolant supply portion or the coolant collection portion which is adjacent to the first liquid connection portion or a distance between a center of the second liquid connection portion and a center of the coolant supply portion or the coolant collection portion which is adjacent to the second liquid connection portion is larger than a distance between the center of the coolant supply portion and the center of the coolant collection portion.

7. The liquid ejection head according to claim 1, wherein
the absorber has a projecting region projecting to a region more outward than the first liquid connection portion or the second liquid connection portion in a plan view seen from an upper surface of the casing.

8. The liquid ejection head according to claim 1, wherein
at least one of the first liquid connection portion and the second liquid connection portion is larger in outer diameter than the coolant supply portion and the coolant collection portion.

9. The liquid ejection head according to claim 1, wherein
a hole diameter of the first opening of the absorber is smaller than an outer diameter of the first liquid connection portion.

10. The liquid ejection head according to claim 1, wherein
a hole diameter of the second opening of the absorber is smaller than an outer diameter of the coolant supply portion.

11. The liquid ejection head according to claim 1, wherein
a hole diameter of the third opening of the absorber is smaller than an outer diameter of the coolant collection portion.

12. The liquid ejection head according to claim 1, wherein
a hole diameter of the fourth opening of the absorber is smaller than an outer diameter of the second liquid connection portion.

13. The liquid ejection head according to claim 1, wherein
the first liquid connection portion is an ink supply portion for supplying ink, and
the second liquid connection portion is an ink collection portion for collecting ink.

14. The liquid ejection head according to claim 1, wherein
the first liquid connection portion is a first ink supply portion for supplying ink, and
the second liquid connection portion is a second ink supply portion for supplying ink.

15. The liquid ejection head according to claim 1, wherein
a plurality of the drive element substrates are provided, and
in a plan view seen from an upper surface of the casing, the plurality of drive element substrates are disposed symmetrically with respect to the coolant supply portion and the coolant collection portion.

16. A liquid ejection apparatus comprising:
a liquid ejection head having
a liquid ejection unit having an ejection element substrate having an ejection element for ejecting liquid from an ejection port, a drive element substrate provided with a drive element for driving the ejection element, and a cooling member having a coolant flow channel in which a coolant for cooling the drive element substrate flows and disposed in contact with the drive element substrate and
a casing covering the liquid ejection unit,
the liquid ejection head being, at an upper surface of the liquid ejection unit with the liquid ejection head being in a posture during use, provided with a coolant supply portion for suppling the coolant to the coolant flow channel, a coolant collection portion for collecting the coolant from the coolant flow channel, and a first liquid connection portion and a second liquid connection portion for at least supplying a liquid to the ejection element,
the liquid ejection head being, at an upper surface of the casing with the liquid ejection head being in the posture during use, provided with an absorber surrounding the coolant supply portion, the coolant collection portion, the first liquid connection portion, and the second liquid connection portion,
the absorber having a first opening to pass the first liquid connection portion through, a second opening to pass the coolant supply portion through, a third opening to pass the coolant collection portion through, and a fourth opening to pass the second liquid connection portion through, and
in a case where the absorber is divided into three regions which are equal in area in a plan view seen from an upper surface of the absorber, the three regions being a first region including the first opening, a second region including the second opening and the third opening, and a third region including the fourth opening;
a plurality of liquid connection portions on a main body side of the liquid ejection apparatus connected to the first liquid connection portion and the second liquid connection portion, respectively; and
a plurality of coolant connection portions on the main body side of the liquid ejection apparatus connected to the coolant supply portion and the coolant collection portion, respectively.
